(19) United States
(12) Patent Application Publication
(10) Pub. No.: US 2008/0038057 A1
(43) Pub. Date: Feb. 14, 2008

(54) Bollard assembly

(76) Inventor: David M. Stadler, Lathrup Village, MI (US)

Correspondence Address: L.C. Begin & Associates, PLLC, 510 Highland Avenue, PMB 403, Milford, MI, 48381, US

(21) Appl. No.: 11/880,758

(22) Filed: Jul. 23, 2007

Related U.S. Application Data
(60) Provisional application No. 60/832,781, filed on Jul. 24, 2006.

(51) Int. Cl. E01F 13/04; E01F 15/00; F16C 3/03; F16K 15/00

(52) U.S. Cl. 404/6; 251/337; 404/9; 74/1 R

(57) ABSTRACT

A telescoping bollard assembly is provided. The bollard assembly includes a threaded shaft and a shaft housing structure containing a lubricant source in fluid communication with the shaft threads. A lubricant is positioned in the lubricant source in contact with the threaded portion of the shaft. A funnel portion is in fluid communication with the lubricant source, and a shaft guide portion is in fluid communication with the funnel portion. A portion of the shaft projects to an exterior of the housing through a shaft exit portion. The shaft exit portion is in fluid communication with the shaft guide portion and defines a flow path for the lubricant to the lubricant source. Rotation of the shaft urges lubricant from the lubricant source sequentially into the funnel portion, the shaft guide portion, and the shaft exit portion, whereby the lubricant is returned to the lubricant source.

### CROSS-REFERENCE TO RELATED APPLICATIONS

The present application claims the benefit of U.S. Provisional Application Ser. No. 60/832,781, filed on Jul. 24, 2006.

### BACKGROUND OF THE INVENTION

A bollard is typically employed to prevent vehicular traffic inward or past the point of the bollard. Accordingly, any building or structure that requires protection may be protected by a plurality of bollards deployed about the periphery thereof. From a design standpoint, bollards must be strong enough to prevent and/or substantially slow movement of a vehicle between the bollard and the structure to be protected. Furthermore, periodically, vehicular access is desired and therefore the bollards must be designed in retractable fashion, thereby permitting vehicular travel over the recessed bollard.

Several retractable bollard designs are known and employ various deployment methods including hydraulic or pressurized gas means. Hydraulic bollards are disadvantaged by seals that sometimes deteriorate and result in a loss of hydraulic fluid pressure. On the other hand, bollards supported by gaseous pressure are disadvantaged by the loss of volume sometimes exhibited as ambient temperatures decrease. As with a loss of hydraulic pressure, the efficacy of the bollard comes into question as the supporting fluidic pressure is reduced. Furthermore, retractable bollards that function based on fluidic pressure must be maintained to ensure operability over extended periods of time.

### BRIEF DESCRIPTION OF THE DRAWINGS

In the drawings illustrating embodiments of the present invention:

FIG. 1 shows a cross-sectional view of a bollard assembly in accordance with the present invention in a retracted state.

FIG. 2 shows a cross-sectional view of a bollard assembly in accordance with the present invention in a raised or actuated state.

FIGS. 3 and 4 show views of a cup flange mountable in the bollard assembly shown in FIGS. 1 and 2.

FIG. 5 shows a cross-sectional view of a shaft assembly including a lubricant circulation system mounted in the bollard assembly shown in FIGS. 1 and 2.

FIGS. 6 and 7 show views of a shaft guide mountable in the bollard assembly shown in FIGS. 1 and 2.

FIGS. 8, 9, and 9a show views of a drive head housing mountable in the bollard assembly shown in FIGS. 1 and 2.

FIGS. 10 and 11 show views of an access flange mountable in the bollard assembly shown in FIGS. 1 and 2.

FIG. 12 shows a view of a cover plate mountable in the bollard assembly shown in FIGS. 1 and 2.

FIG. 13 shows a view of an extension housing mountable on the bollard assembly shown in FIGS. 1 and 2.

FIGS. 14 and 15 show views of valve assemblies mountable in the bollard assembly shown in FIGS. 1 and 2.

FIGS. 15, 16, and 17 show views of a portion of a drive head assembly mountable in the bollard assembly shown in FIGS. 1 and 2.

FIG. 18 shows a magnified cross-sectional view of a portion of the bollard assembly of FIG. 1.

FIG. 19 shows a magnified cross-sectional view of a portion of the bollard assembly shown in FIG. 2, in a partially raised state.

### DETAILED DESCRIPTION

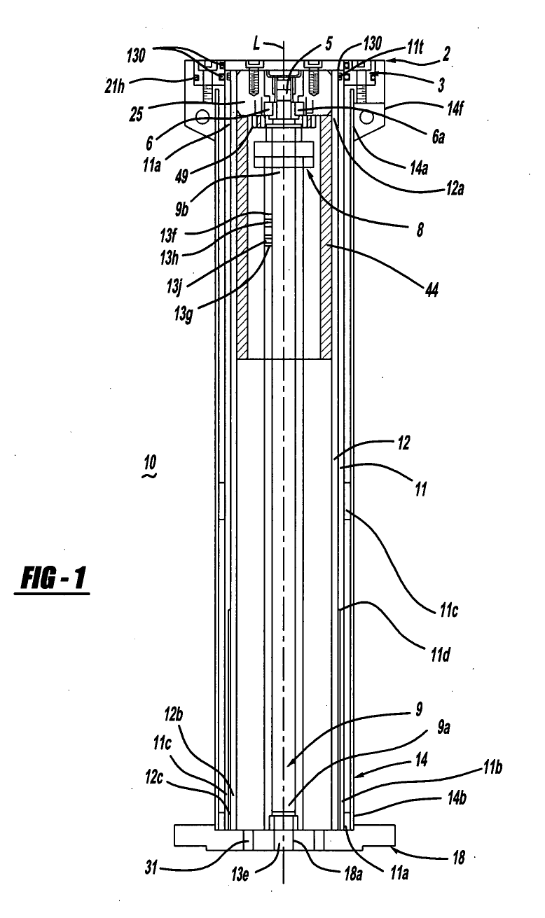

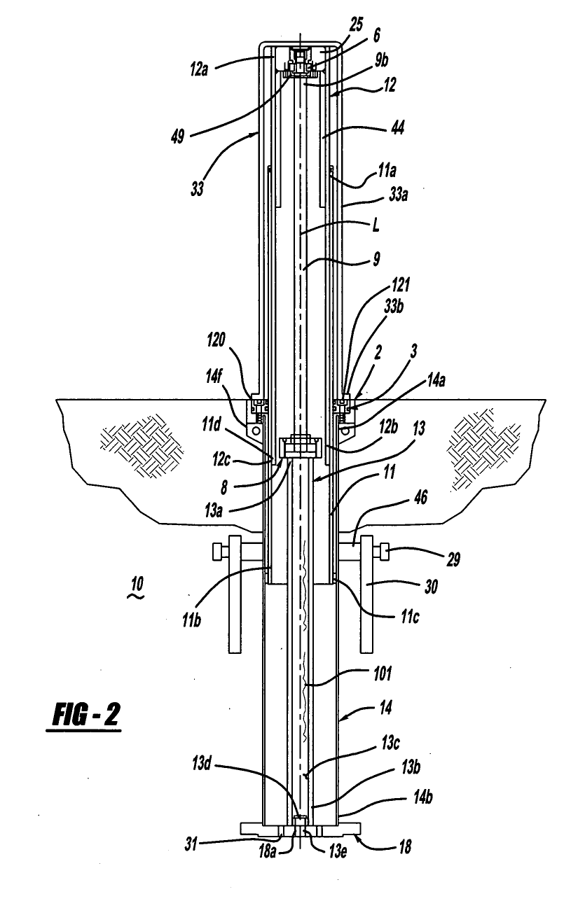

FIGS. 1 and 2 show cross-sectional views of a bollard assembly 10 in accordance with one embodiment of the present invention. As seen in FIGS. 1 and 2, bollard assembly 10 includes is retractable and operable on a screw drive shaft 9. Bollard assembly 10 also includes a base flange 18 and a bollard housing 14 secured to the base flange for mounting of the other bollard assembly components therein. Most components of the bollard assembly may be nitride coated using known processes for maximum corrosion protection and wear resistance. After nitride coating of a component, an auto ferritic may be applied by any suitable vendor (for example, Henkels & McCoy of Blue Bell, Pa.) to enhance corrosion resistance.

Housing 14 has a first end 14a and a second end 14b. Housing 14 is formed from steel plate which is rolled into a cylinder having a longitudinal axis L, and welded along a seam. The basic steel tube from which housing 14 is formed can be fabricated by any suitable vendor, for example Defasco, Inc. Additional features may be finish machined onto the tube as desired for a particular application.

Anchoring the bollard housing 14 is achieved in a known manner, by excavating a suitable space in the ground to enable the bollard assembly to be inserted to a point where an uppermost surface of cup flange 2 resides at approximately ground level. As shown in FIG. 2, anchor bolts 29 may be provided to affix perforated anchor flanges 30 (or other protrusions suitable for providing a bearing surfaces for poured cement) via coupler sleeves 46 welded to housing 14. Anchor flanges 30 have holes and serrations to allow greater anchoring area for encapsulation by liquid cement poured into the anchoring hole to enclose the below-ground portion of the bollard assembly.

Referring to FIG. 13, for applications in which the bollard assembly is to be installed in ground having less than ideal soil conditions for securement of the bollard therein, an extension housing 51 may be bolted to base flange 18 via bolt bores 52 formed in an adapter flange 50. The overall length of extension housing 50 may be varied to provide additional mounting strength for the bollard assembly, according to the soil conditions and to the mounting and stability requirements of a particular application. Multiple perforations 53 formed in extension housing 51 allow liquid cement to fill the inside and around the outside of the extension housing to provide additional strength and stability to the bollard assembly mounting.

Bollard housing base flange 18 is welded or otherwise fixed to the housing second end 14b thereby providing a support base for the entire bollard assembly 10. A threaded hole 18a is provided in flange 18 for receiving therein a complimentarily threaded stud 13e affixed to a stanchion 13 (described in greater detail below). If desired, the housing base flange 18 may include one or more orifices 31 for drainage of any moisture that accumulates within housing 14. Base flange 18 is formed from steel or another suitable metal or metal alloy using known methods.

As shown in the Figures, one or more lifting ears 14f may be welded or otherwise fixed to bollard housing 14, thereby facilitating movement of the bollard assembly 10 by attachment to one or more of the lifting ears.

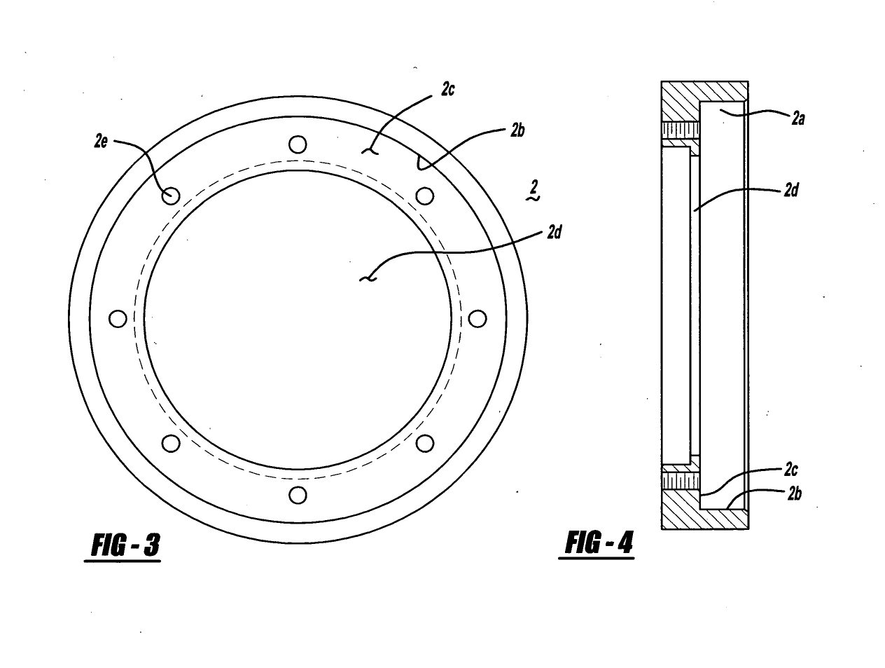

Referring to FIGS. 1-4, a cup flange 2 is welded or otherwise suitably secured to housing first end 14a. Cup flange 2 has a counterbore 2a formed therein which defines a sidewall 2b and a floor 2c. A central through hole 2d is sized to permit passage of outer bollard tube 11 (described below) therethrough during actuation of the bollard assembly. A series of tapped holes 2e may be distributed along cup flange floor 2c to enable bolting of an access flange 3 (described below) thereto. Cup flange 2 is formed from steel using known methods.

Referring to FIGS. 1 and 2, stanchion 13 includes a steel cylindrical tube secured within housing 14. Stanchion 13 has a first end 13a, a second end 13b opposite the first end, and an internal bore 13c extending through the length of the tube. A floor 13d is welded or otherwise secured to end 13b. Floor 13b has a stud 13e affixed therein and extending from an outside face thereof to enable engagement with complementary threads formed in threaded hole 18a of base flange 18. The diameter of stanchion bore 13c is sized to house a shaft guide 22 enclosing a portion of threaded shaft 9, which is used to extend and retract bollard assembly 10 in a manner described in greater detail below. Floor 13b is secured to the stanchion tube so as to provide a sealed enclosure for containing therein a lubricant 101 used to lubricate shaft 9 during extension and retraction of the bollard assembly. Thus, the stanchion enclosure serves as a reservoir for the lubricant. In general, lubricant 101 may occupy a sufficient portion of the stanchion internal volume so as to immerse shaft 9 in lubricant along anywhere from ½ up to ⅔ of the length of the shaft, depending on the lubricant and the particular application. Lubricant 101 may have any viscosity, composition, or other properties suitable for lubricating drive shaft 9 under the given environmental conditions in which the bollard will operate.

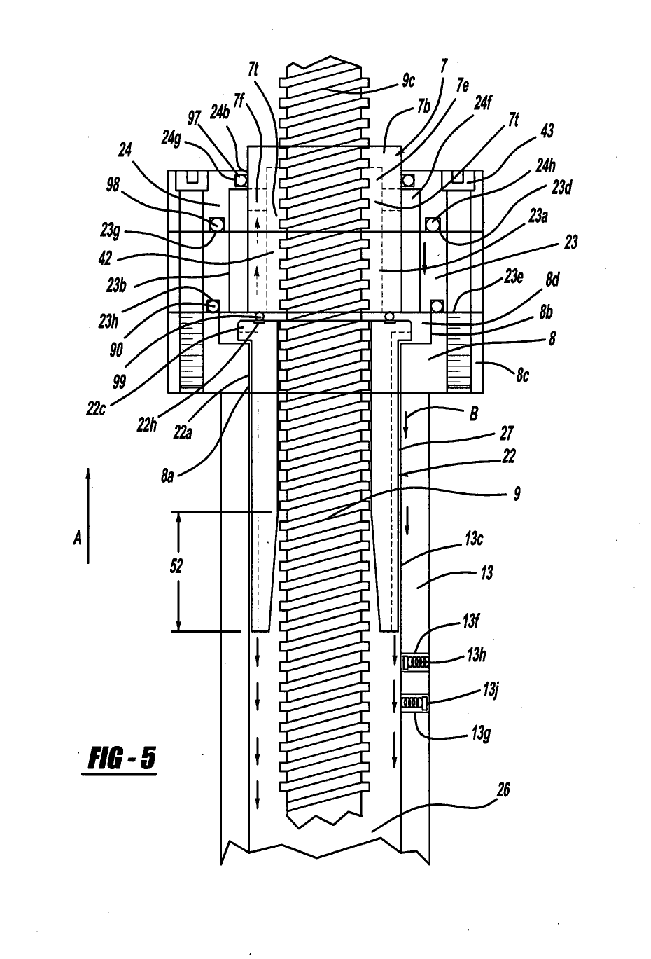

Stanchion 13 is secured to base flange 18 by screwing stud 13e into hole 18a. Alternatively, stanchion 13 may be welded to base flange 18 prior to attachment of housing 14 to the base flange. Referring to FIG. 5, stanchion 13 also includes openings 13f and 13g to enable the mounting of an inlet valve 13h and an outlet valve 13j therein. Valves 13h and 13j are shown schematically in FIG. 5, and are configured to permit automatic flow of air into or out of stanchion 13, to equalize the pressure inside the stanchion with the pressure outside the stanchion during actuation of the bollard assembly. Valves 13h and 13j may be any type of valve (for example, poppet valves) suitable for performing the pressure equalization function.

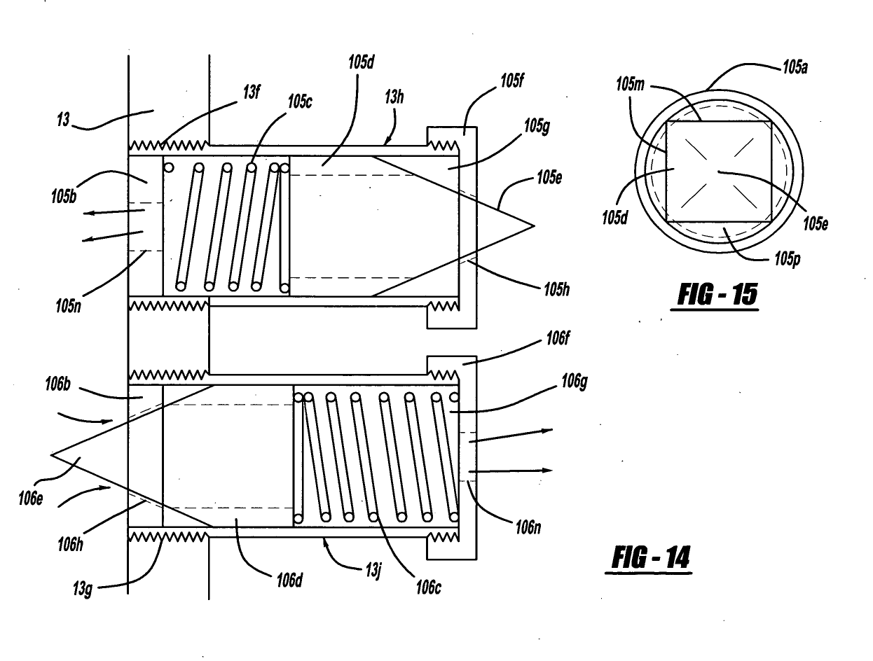

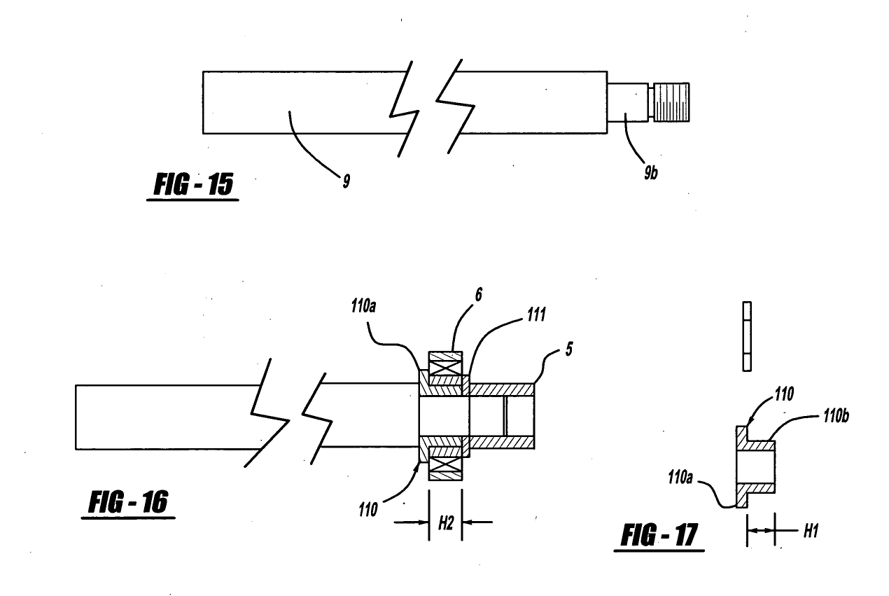

A particular embodiment of valves 13h and 13j are shown in FIGS. 14 and 15. A substantially cylindrical valve body 105a is formed from tubing made from steel, aluminum, or any other suitable material. Valve body 105a is press-fit or screwed into opening 13f formed in the wall of stanchion 13. An exit plate 105b is secured within a first end of valve body 105a. Exit plate 105b has a through orifice 105n formed therein to enable fluid communication between an interior of the valve body and an interior of stanchion 13. One end of a spring member 105c (such as a coil spring or any other suitable type of spring member) bears against exit plate 105b. Another end of spring 105c bears against a closure member 105d. Closure member 105d is formed from a piece of square stock (made from steel, aluminum, or any other suitable material) machined at one end to form a substantially conical tip 105e. A cap 105f (made from steel, aluminum, or any other suitable material) has a cavity 105g formed therein with an inner diameter sized to enable securement of the cap (via a threaded connection or a press-fit) over a free end of valve body 105a. Cap 105f has an opening 105h in the shape of a conical section corresponding to the conical shape of tip 105e. Opening 105h is configured to engage and abut tip 105e so as to close the opening when closure member 105 is urged against the opening by spring member 105c, thereby blocking a flow of air from the stanchion interior to an exterior of the stanchion through valve 13h.

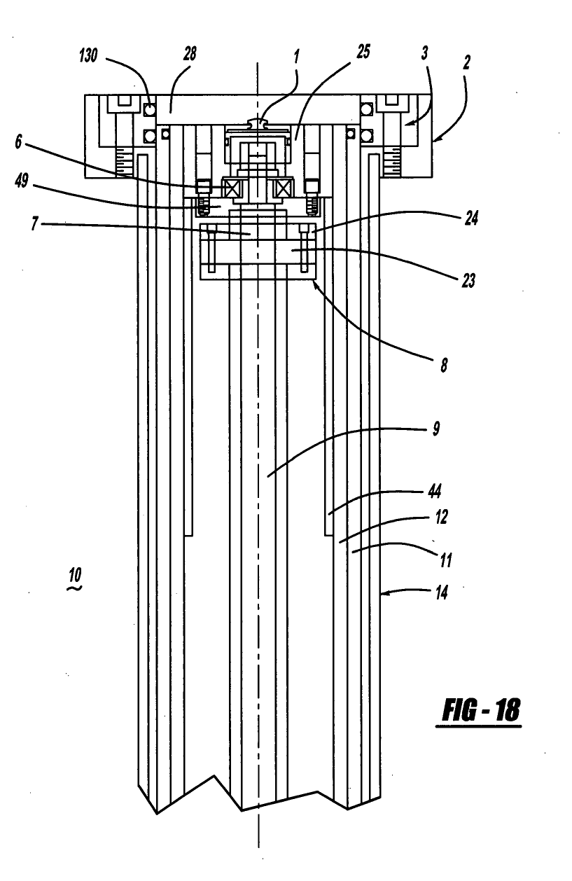

During raising or expansion of the bollard assembly, displacement of the bollard assembly internal components will tend to reduce the pressure within the bollard assembly. Valve 13h permits air to enter the stanchion interior during bollard actuation, to provide a compensatory increase in bollard internal pressure. Referring to FIGS. 15 and 16, as the bollard assembly internal pressure is reduced, the pressure differential between the interior and exterior of the bollard causes closure member 105d to displace toward the stanchion, thereby opening hole 105h and permitting a flow of air therethrough. As a body of closure member 105d is formed from square stock, this air flows through the gaps 105p between sides 105m of closure member 105d and the wall of valve body 105a, through the spring member 105c, and into stanchion 13 via orifice 105n. When the pressure differential diminishes to a certain value, the force exerted by spring member 105 overcomes the pressure force acting on tip 105e, thereby forcing the tip back into conical opening 105h to close the valve.

The structure and operation of valve 13j are substantially similar to that of valve 13h. However, valve 13j enables flow of air out of stanchion 13, rather than into the stanchion. A substantially cylindrical valve body 106a is formed from tubing made from steel, aluminum, or any other suitable material. Valve body 106a is press-fit or screwed into opening 13g formed in the wall of stanchion 13. A cap 106f (made from steel, aluminum, or any other suitable material) has a cavity 106g formed therein with an inner diameter sized to enable securement of the cap (via a threaded connection or a press-fit) over a free end of valve body 106a. Cap 106f has a through orifice 106n formed therein to enable fluid communication between an interior of the valve body and an interior of stanchion 13. One end of a spring member 106c (such as a coil spring or any other suitable type of spring member) bears against cap 106f Another end of spring 106c bears against a closure member 106d. Closure member 106d is formed from a piece of square stock (made from steel, aluminum, or any other suitable material) machined at one end to form a substantially conical tip 106e. An entry plate 106b is secured within a first end of valve body 106a. Entry plate 106b has an opening 106h in the shape of a conical section corresponding to the conical shape of tip 106e. Opening 106h is configured to engage and abut tip 106e so as to close the opening when closure member 106 is urged against the opening by spring member 106c, thereby blocking a flow of air from the exterior of the stanchion interior to an interior of the stanchion through valve 13j.

During lowering or contraction of the bollard assembly, displacement of the bollard assembly internal components will tend to increase the pressure within the bollard assembly. Valve 13j permits air to exit the stanchion interior during bollard actuation, to provide a compensatory decrease in bollard internal pressure. Referring to FIGS. 15 and 16, as the bollard assembly internal pressure increases, the pressure differential between the interior and exterior of the bollard causes closure member 106d to displace away from the stanchion, thereby opening hole 106h and permitting a flow of air therethrough. As a body of closure member 106d is formed from square stock, this air flows through the gaps between the sides of closure member 106d and the wall of valve body 106a (as described above), through the spring member 106c, and into stanchion 13 via orifice 106n. When the pressure differential diminishes to a certain value, the force exerted by spring member 106 overcomes the pressure force acting on tip 106e, thereby forcing the tip back into conical opening 106h to close the valve.

If desired, a suitable lubricant, coating, or surface treatment may be applied to closure members 105d, 106d and/or to the interior surfaces of valve bodies 105a, 106a to facilitate low-friction movement of the closure members within their respective valve bodies. In addition, as known in the art, spring members 105c, 106c may be specified so as to permit actuation of the closure members within any one of a variety of desired ranges of pressure differential.

Referring to FIGS. 1, 2, and 5, a stanchion flange 8 is welded or otherwise suitably secured to stanchion first end 13a. Flange 8 has a central through hole 8a and a counterbore 8b formed therein. Hole 8a and counterbore 8b are sized to receive therein a shaft guide 22 (described below). Flange 8 also has multiple tapped blind holes 8c formed therein for receiving complimentarily threaded ends of bolts (not shown) used for securing a threaded nut flange 23 (described below) and a lubricant flow director 24 (also described below) to flange 8. Stanchion flange 8 is formed from steel or another suitable metal or metal alloy, using known techniques.

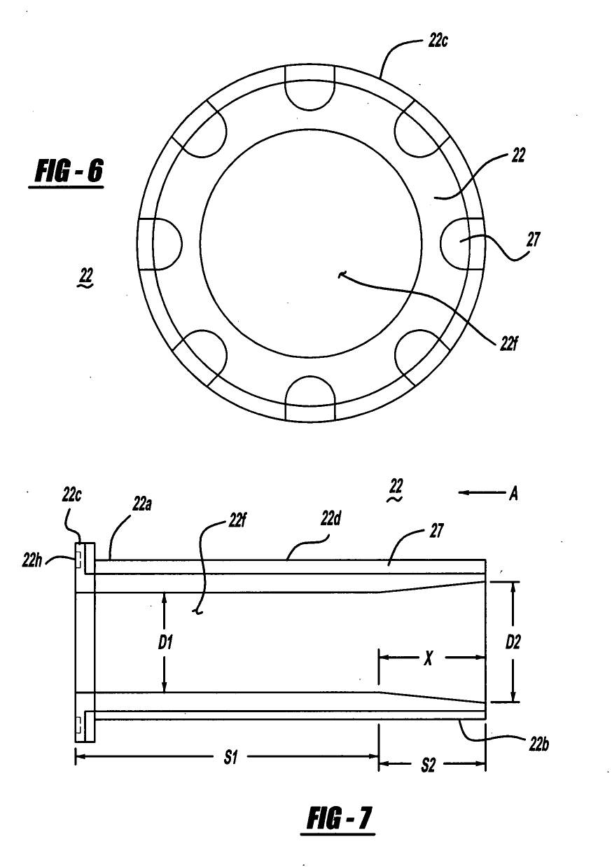

Referring to FIGS. 5, 6, and 7, shaft guide 22 extends through stanchion flange hole 8a and into stanchion bore 13c. Shaft guide 22 has a first end 22a, a second end 22b opposite the first end, and an internal bore 22f extending through the length of the tube. Shaft guide 22 also includes a flange 22c at first end 22a and a body 22d extending below flange 22c. Shaft guide flange 22c has a dimension sized to exceed the diameter of stanchion bore 13c such that flange 22c rests in a well 8d is formed within the counterbore between flange 22c and a wall of the counterbore. A diameter D1 of a first portion S1 of shaft guide bore 22f is sized to enclose a portion of threaded shaft 9 in a slight clearance fit, thereby providing a shaft guide to aid in centering and bracing the shaft during rotation. A diameter of a second portion S2 of shaft guide bore 22f is designed to decrease from a first value D2 at second end 22b, to D1 at a predetermined distance X from the end of the shaft guide, as described in greater detail below. The portion S2 of the shaft guide bore has the effect of funneling or channeling lubricant into the threads of shaft 9 and into portion S1 of the guide bore, as the lubricant is pressed or urged in the direction indicated by arrow A, by action of the shaft threads during turning of the shaft as the bollard assembly is extended.

Referring to FIGS. 5, 6, and 7, shaft guide 22 also includes a plurality of lubricant return passages 27 formed into a portion of flange 22c and along an exterior surface of shaft guide body 22d. As seen in FIG. 5, when shaft guide 22 is installed within stanchion 13, return passages 27 are in fluid communication with the lubricant reservoir in stanchion 13. The passages 22g aid in directing a return flow of lubricant to the lubricant reservoir in stanchion 13, in a manner described in greater detail below, and as indicated by arrows B in FIG. 5 showing a return flow path of the lubricant. A groove 22h may be formed along an upper surface of flange 22c for accommodating an O-ring 99 (FIG. 5) or other compliant seal therein. Shaft guide 22 is generally cylindrical and is formed from steel or another suitable metal or metal alloy using known methods.

Referring to FIG. 5, threaded nut flange 23 is positioned atop stanchion flange 8 after the insertion of shaft guide 22 into the stanchion flange and stanchion bore 13c. Nut flange 23 has an upper surface 23d, a lower surface 23e, and a threaded bore 23a extending therethrough for threadedly receiving a threaded nut 7 (described below) therein. Nut flange 23 also has a plurality of lubricant return passages 23b formed therein to enable fluid communication between stanchion flange well 8d and another well 24f formed in lubricant flow director 24. A groove 23g may be formed along upper surface 23d of flange 23 for accommodating an O-ring 98 or other compliant seal therein. Similarly, a groove 23h may be formed along lower surface 23e for accommodating O-ring 90 or another compliant seal therein. When Threaded nut flange 23 is positioned atop stanchion flange 8 and bolted thereon, O-ring seal 99 and o-ring seal 90 positioned in nut flange groove 23h is compressed and acts to prevent migration of lubricant radially outwardly from shaft 9, between nut flange 23 and stanchion flange 8 and between nut flange 23 and shaft guide 22. Threaded nut flange 23 is formed from steel or another suitable metal or metal alloy using known methods.

Referring to FIG. 5, threaded nut 7 has an exterior threaded portion (not shown) adapted for engaging complementary threads (not shown) formed in nut flange bore 23a, and a flange portion 7b sized to bear against nut flange upper surface 23d when the threaded nut is fully screwed into nut flange 23. Threaded nut 7 also includes a threaded bore 7c which engages complementary threads formed along the exterior of shaft 9 to enable expansion and retraction of the bollard assembly, in a manner described in greater detail below. Thus, threaded nut 7 threadedly engages and supports shaft 9.

A pair of axially-extending lubricant flow passages 7t disposed approximately 180° apart is formed along threaded bore 7c adjacent shaft 9. In addition, one or more flow channels 7f extend radially outwardly from (and in fluid communication with) flow well 7e to enable fluid communication between well 7e and a well 24f formed in a cap 24 (described below) positioned and secured atop threaded nut flange 23. Threaded nut 7 is formed from steel or another suitable metal or metal alloy using known methods.

As seen in FIG. 5, a cap 24 is bolted atop threaded nut flange 23. Cap 24 has a cavity 24f formed therein, and a central bore 24b extending through the length of the cap. Cavity 24f defines a well for receiving therein a flow of lubricant from flow passages 7f formed in threaded nut 7, as previously described. Central bore 24b is dimensioned to provide a slight clearance fit with threaded nut 7 received therein. A groove 24g is formed along a surface 24e of the cap residing adjacent threaded nut 7 for accommodating O-ring 97 or another compliant seal therein. Also, a groove 24h may be formed along lower surface 23e for accommodating O-ring 98 or another compliant seal therein. When cap 24 is positioned atop threaded nut flange 23 and bolted thereon, O-ring seal 98 positioned in either nut flange groove 23g or cap groove 24h is compressed and acts to prevent migration of lubricant radially outwardly from shaft 9, between nut flange 23 and cap 24. Similarly, when cap 24 is positioned over threaded nut 7, O-ring 97 is compressed to provide a seal between the threaded nut and the cap, to prevent migration of lubricant from cavity 24f between the threaded nut and the cap. Cap 24 is formed from steel or another suitable metal or metal alloy using known methods.

Thus, as described herein, stanchion 13, stanchion flange 8, shaft guide 22, threaded nut flange 23, threaded nut 7, and cap 24 form a shaft housing structure that incorporates therein a circulation system for the shaft lubricant 101.

Referring to FIGS. 1, 2, 5, and 15, threaded shaft 9 is threadedly engaged with and supported by threaded nut 7. The shaft extends from stanchion 13, passing through stanchion flange 8, threaded nut flange 23, and cap 24, and into the interiors of inner bollard tube 12 and outer bollard tube 11. Threaded Shaft 9 has a first end 9a, a threaded second end 9b, and a plurality of threads 9c formed therealong. Shaft first end 9a resides within stanchion 13. Shaft end 9b is rotatably coupled (in a manner described in greater detail below) to an end portion of inner bollard tube 12 such that rotation of the shaft causes shaft threads 9c to engage the complementary threads in threaded nut 7 (described below) so as to either extend or retract the bollard assembly, depending on the direction of shaft rotation. As is known in the art, the characteristics of threads 9c may be varied according to the needs of a particular application. For example, a relatively greater number of threads per unit length of the shaft may be formed along shaft 9 if it is desired to reduce the amount of torque required to rotate shaft 9 and actuate the bollard assembly. However, providing a greater number of threads per unit length may correspondingly increase the time required to actuate the bollard. Shaft 9 is formed from steel or another suitable metal or metal alloy using known methods.

Referring to FIGS. 1, 2, 15, 16, and 17, a bushing 110 is pressed onto second shaft end 9b, and bearing 6 is pressed onto bushing 110 so that the bearing rests on a flange 110a of the bushing. A body 110b of bushing 110 is sized such that a length H1 (FIG. 17) of the bushing body slightly exceeds a depth H2 (FIG. 16) of the bearing. Bearing 6 provides a thrust surface 6a on an upper face of the bearing which bears against a drive head housing 25 (described below) affixed to inner bollard tube 12 to extend and retract the bollard assembly. Bearing 6 also permits rotation of shaft 9 with respect to thrust surface 6a.

A washer 111 is applied to shaft 9 over bearing 6. Washer 111 acts as a spacer between bearing 6 and bushing 110. Prior to application of drive nut 5, washer 111 is slightly spaced apart from bearing 6 due to the difference between bushing body length H1 and bearing depth H2.

Referring to FIGS. 1, 2, 15, 16, and 17, a drive head or nut 5 is screwed onto the threaded end of shaft end 9b, over washer 111. Drive nut 5 is affixed to shaft second end 9b so as to enable rotation of the shaft by rotation of the drive nut. Drive nut 5 has a cavity formed therein with a periphery shaped to engage a proprietary tool head used for turning the drive nut and shaft 9 which is affixed thereto, thereby actuating the bollard assembly. To secure the drive nut to the shaft and to prevent rotation of the drive nut with respect to the shaft, a pin is inserted through a wall of the drive nut and into the portion of the shaft end enclosed by the drive nut. A suitable epoxy or adhesive is then applied to a contact interface between the drive nut and the shaft. In addition, when drive nut 5 is screwed onto the shaft, the drive nut is tightened such that the bearing 6 is compressed between washer 111 and bushing flange 110a, thereby closing the slight clearance gap between washer 111 and bearing 6, to more tightly secure the bearing between washer 111 and bushing flange 110a.

A bearing retainer plate 49 is affixed to an underside of drive head housing 25 for securing bearing 6 to drive head housing 25. Retainer plate 49 includes at least a pair of threaded holes for receiving therein complimentarily threaded portions of bolts 130 inserted in the drive head housing, as described below.

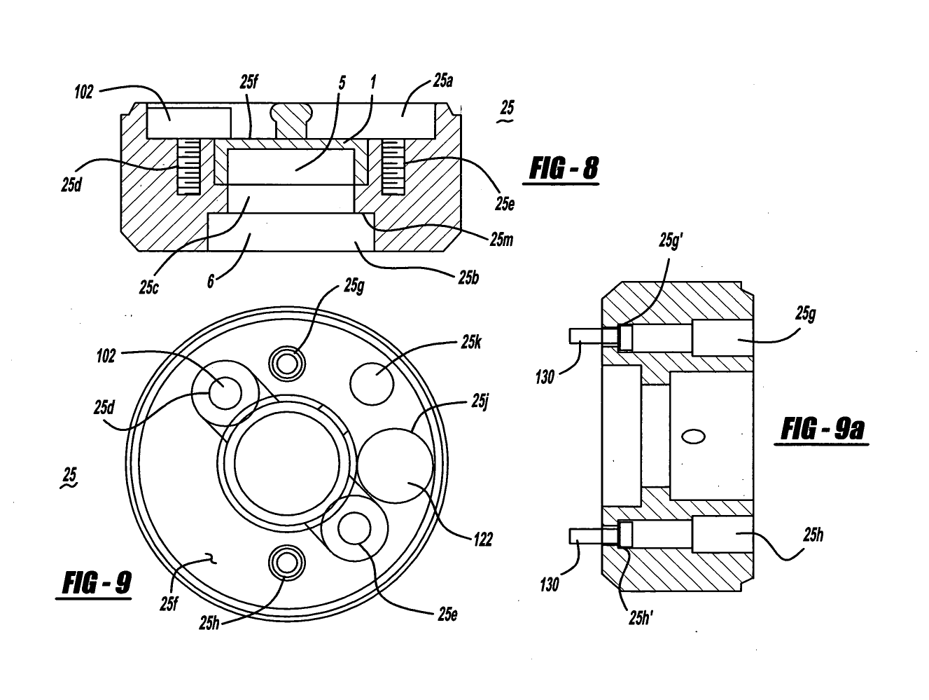

Referring to FIGS. 1, 2, 8, and 9, drive head housing 25 is sized to fit within an inner diameter of inner bollard tube 12 (described below) to enable welding of housing 25 to inner tube 12 within an upper end of the tube, as shown in FIGS. 8 and 9. Drive head housing 25 includes a first counterbore 25a formed in a first side of the housing, a second counterbore 25b formed in an opposite side of the housing, and a first through hole 25c extending between, and connecting, counterbores 25a and 25b. First counterbore has a floor 25f into which at least a pair of threaded holes 25d, 25e are formed. Second and third through holes 25g and 25h are provided to permit portions of a bollard disassembly tool (not shown) to be inserted into the drive head housing to engage the drive head housing, enabling lifting of the drive head housing, inner bollard tube 12, and the remaining portions of the bollard assembly attached thereto. This permits the components of the bollard assembly to be withdrawn from the bollard housing for servicing.

In addition, end portions 25g′ and 25h′ of holes 25g and 25h, respectively, are adapted to engage and support the heads of bolts 130 inserted into holes 25g and 25h from the side of the drive head housing into which first counterbore 25a is formed. Threaded ends of bolts 130 are threadedly received in complimentarily threaded holes formed in retainer plate 49, to secure the retainer plate to drive head housing 25.

A blind hole 25j provides a cavity for receiving therein a known radio frequency (RF) device 122 configured to emit a predetermined signal when the bollard assembly is damaged or tampered with. One or more vent holes 25k may also be formed in drive head housing 25 for venting air from the interior of the bollard assembly during actuation of the bollard assembly. Second counterbore 25b and first through hole 25c are configured for receiving therein portions of bearing 6 and drive head 5. A floor 25m of second counterbore 25b provides the bearing surface against which bearing 6 acts to enable extension of the bollard assembly using shaft 9, in a manner described in greater detail below. Through hole 25c provides access (through first counterbore 25a) to drive head 5, whereby an actuation tool can be applied to the drive head to rotate the drive head, thereby actuating the bollard assembly.

In one particular example, device 122 is self-contained and utilizes a sparse pulse methodology to transmit bollard assembly height changes on a real-time basis if there is tampering or any unauthorized access. Device 122 can also send notification of temperature, vibration, or other programmed data. Battery life is relatively long due to a transmission rate of only 5 pulses per minute. A transmission frequency band of 303 MHz to 450 MHz allows the emitted signal to be received up to a distance of 1200 ft. from the bollard assembly. The signal can then be recorded or boosted for further transmission. Each device 122 has a distinctive electronic “I.D.” tag. Tampering with device 122 or with the bollard assembly is evidenced immediately upon cessation of signal transmission from the device. Device 122 may be positioned atop or exterior of a protective sleeve (described below) covering the bollard assembly if desired, to permit an unobstructed signal transmission.

Referring to FIGS. 1 and 2, outer bollard tube 11 has a first end 11a and a second end 11b. Outer tube 11 is formed from steel plate which is rolled into a cylinder having a longitudinal axis L, and welded along a seam. A shoulder 11c is machined along an outer surface of second end 11b intermediate first and second ends 11a and 11b to provide a positive stop which engages an inner diameter of access flange through bore 3a during extension of the bollard, to limit upward motion of the outer tube. Also, a shoulder 11t is machined along an outer surface of second end 11b to bear against an interior surface of housing 14 during actuation of the bollard assembly, to aid in centering and steadying the outer tube during movement within the housing. In addition, a shoulder 11d is machined along an interior surface of the outer tube, intermediate the first and second ends of the tube, to provide a positive stop which engages a complementary shoulder 12a formed along an exterior surface of inner bollard tube 12 (described below) during extension of the bollard to limit upward motion of inner tube 12, in a manner described in greater detail below. Shoulders 11c and 11d generally extend along a plane substantially perpendicular to axis L. The basic steel cylinder from which outer tube 11 is formed can be fabricated by any suitable vendor, for example Defasco, Inc. Additional features may be finish machined onto the tube as desired for a particular application.

Also, a groove 11t is formed along an interior surface of outer bollard tube first end 11a for accommodating a known hydraulic rod seal 130 or other compliant seal therein. Seal 130 engages an outer surface of inner bollard tube 12 as shown in FIG. 1 to provide a seal for preventing moisture from migrating into the bollard assembly interior between the inner and outer bollard tubes.

Referring to FIGS. 1 and 2, inner bollard tube 12 has a first end 12a and a second end 12b. First end 12a has drive head housing 25 inserted therein and welded of otherwise suitably secured in place. A shoulder 12c is machined along an outer surface of second end 12b to provide a positive stop which engages outer tube interior shoulder 11d during extension of the bollard, to limit upward motion of the inner tube, in a manner described in greater detail below. Shoulder 12c generally extends along a plane substantially perpendicular to axis L. Inner tube 12 is formed from steel plate which is rolled into a cylinder having a longitudinal axis L, and welded along a seam. The basic steel tube from which inner tube 12 is formed can be fabricated by any suitable vendor, for example Defasco, Inc. Additional features may be finish machined onto the tube as desired for a particular application.

Referring to FIGS. 1 and 2, an inner bollard reinforcement 44 is welded to an underside of drive head housing 25. As seen in FIGS. 1 and 2, reinforcement 44 is designed to extend downward from drive head housing_and to overlap a region where inner bollard tube 12 projects from outer bollard tube 11 when the bollard is extended. The reinforcement thus increases the effective thickness of the portion of inner tube 12 projecting from outer tube 1, thereby increasing the strength and impact resistance of this portion of the bollard assembly. Reinforcement 44 is formed from steel plate which is rolled into a cylinder having a longitudinal axis L, and welded along a seam. The basic steel tube from which reinforcement 44 is formed can be fabricated by any suitable vendor, for example Defasco, Inc. Additional features may be finish machined onto the tube as desired for a particular application.

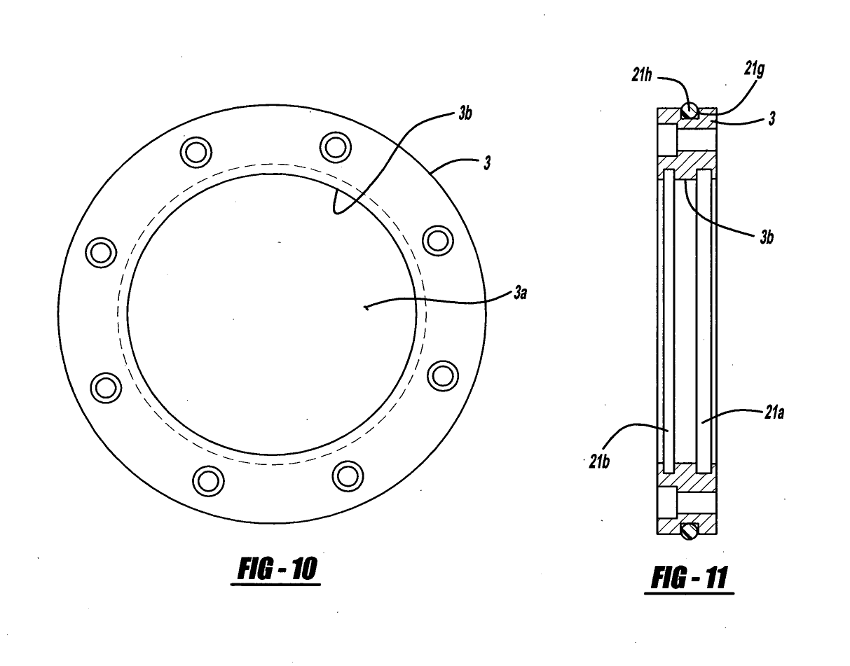

Referring to FIGS. 1, 10, and 11, an access flange 3 is positioned and bolted or otherwise secured within cup flange counterbore 2a. Access flange 3 has a through bore 3a defined by a wall 3b. Bore 3a is sized to permit passage of outer bollard tube 11 therethrough during actuation of the bollard assembly. A first groove 21a is formed along wall 3b for accommodating a first known hydraulic rod seal 130 or other compliant seal therein. This first seal engages outer bollard tube 11 to provide a seal to prevent moisture from migrating into the bollard assembly interior between access flange 3 and outer tube 11. A second groove 21b is formed along wall 3b for accommodating a second known hydraulic rod seal 130 or other compliant seal therein. The second seal engages a cover plate 28 (described below) when the cover is positioned and secured within cup flange counterbore 2a, to provide a seal for preventing moisture from migrating into the bollard assembly interior between cover 28 and the cup flange wall. Access flange 3 is formed from steel or another suitable metal or metal alloy using known methods.

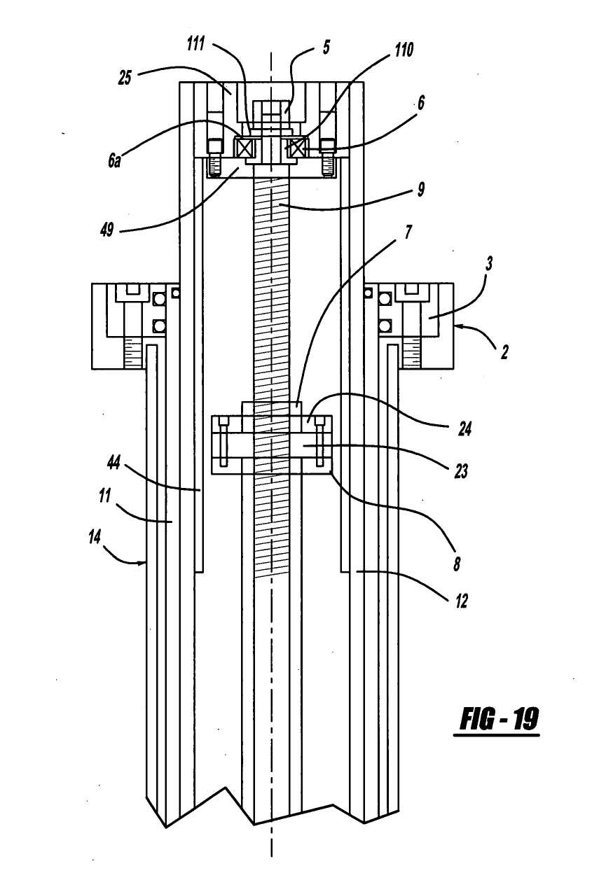

Also, a third groove 21g is formed along a periphery of the access flange for accommodating an O-ring 21h or other compliant seal therein. Seal 21h engages a wall of cup flange 2 as shown in FIGS. 1, 2, 18, and 19 when the access flange is positioned and secured within cup flange counterbore 2a, to provide a seal for preventing moisture from migrating into the bollard assembly interior between access flange 2 and the cup flange wall.

Referring to FIGS. 1, 8, 9, and 18, when bollard assembly 10 is in a retracted configuration, a lock cap 1 is secured over drive head 5 to aid in preventing unauthorized access to the drive nut. As seen in FIGS. 8 and 9, threaded bore 25b in drive head housing 25 is located with respect to first through hole 25c so as to enable the head of a proprietary bolt 102 screwed into bore 25b to cover a portion of lock cap 1 when the lock cap is positioned over drive head 5. This aids in preventing unauthorized removal of lock cap 1 from drive head 5. Bolt 102 has a head designed to accept therein a proprietary tool (not shown) for turning the bolt.

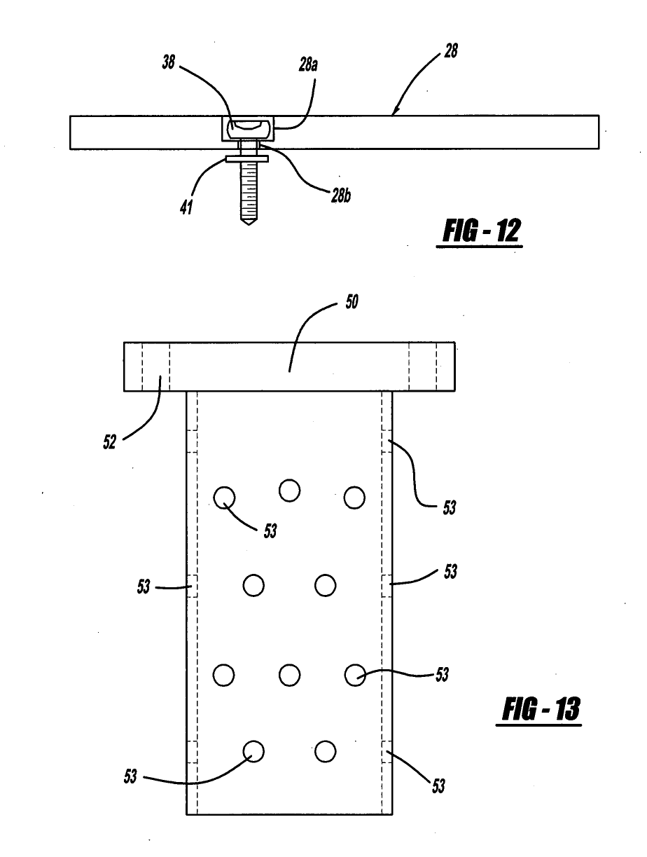

Referring again to FIGS. 1, 12, and 19, when bollard assembly 10 is in a retracted configuration, a cover plate 28 is secured within access flange 3 to cover drive head housing 25. Cover plate 28 has one or more counterbores 28a and one or more corresponding through holes 28b formed therein, each for receiving the shank and head of a proprietary bolt 38. Bolt 38 may incorporate the same proprietary head design as bolt 102 securing lock cap over drive nut, as previously described. Alternatively, for added security, bolt 38 may have a proprietary head configured for accepting an actuation tool different from the tool used to turn drive head housing bolt 102. Bolt 38 is designed to screw into threaded hole 25e in drive head housing, thereby securing the cover plate to the drive head housing. When bolt 38 is installed in cover plate 28, a snap ring 41 is placed along the shank of each bolt, to prevent the bolt from falling our of hole 28b. In addition, snap ring 41 is positioned along the shank so as to be spaced apart from the cover plate such that, after the bolt is partially unscrewed from drive head housing 25, the snap ring bears against a bottom face of the cover. This enables the head of bolt 38 to be gripped by a user and pulled upward to remove cover 28 from access flange 3. A counterbore (not shown) may be formed in an underside of cover plate 28 for each bolt 38 to accommodate an associated snap ring 41 therein.

Referring to FIG. 2, a protective sleeve 33 may be placed over extended bollard sections 11 and 12 to provide additional protection to the bollard assembly when extended. Sleeve 33 has a body 33a and a flange 33b extending from an end of body 33a. Flange 33b has a plurality of bolt holes (not shown) disposed therealong. A corresponding pattern of threaded bolt holes (not shown) is also formed in an upward-facing surface of drive head housing 25. Sleeve 33 is secured in place with proprietary bolts (not shown) which are threadably received in the drive head housing bolt holes. Also, in an embodiment where the sleeve is to be used, a groove 120 is provided along an upward-facing surface of cup flange 2 for receiving an O-ring 121 or other compliant seal therein. Tightening the proprietary bolts forces protective sleeve flange 33b against O-ring 121 in cup flange 2 and shields the bollard assembly interior from adverse weather conditions.

Operation of bollard assembly 10 will now be discussed with reference to the Figures. When it is desired to actuate the bollard assembly, an appropriate tool is used to remove proprietary bolts 38 in cover plate 28, thereby permitting removal of the cover plate. An appropriate proprietary tool is then used to remove bolt 102 from drive head housing 25, thereby enabling grasping and removal of lock cap 1. An appropriate actuation tool is then inserted into drive head 5 to initiate rotation of the shaft in a first direction, to commence extension or raising of the bollard assembly. As threads on shaft 9 engage complementary threads inside threaded nut 7, shaft 9 rises out of stanchion 13. A quantity of lubricant 101 from stanchion 13 (in which shaft 9 has been immersed) adheres to the shaft threads as the shaft rises.

When threads of shaft 9 begin to enter the shaft guide bore second portion S2, lubricant 101 begins to be squeezed into a smaller and smaller volume, between adjacent threads f1 the shaft, and between the shaft and the walls of bore portion S2. When the threads of shaft 9 enter shaft guide bore portion S1, very little clearance is available for lubricant to be squeezed between the outer diameter of threaded shaft 9 and the wall of bore portion S1. This pressurized advancing lubricant mass is now forced upward into threaded bore 23a of threaded nut flange 23, and then further upward into lubricant flow passages 7t, as the shaft threads continue to advance upward. At the tops of flow passages 7t, lubricant enters radial flow channels 7f and flows radially outwardly into well 24f formed in cap 24. From there, the lubricant flows downward into and along return passages 23b, into well 8d formed in counterbore 8b of the stanchion flange, then into and along shaft guide return passages 27. By this means, the lubricant is recirculated between the threaded nut (where the shaft exits the shaft housing structure) and the lubricant reservoir within the interior of stanchion 13.

As shaft 9 rotates, the shaft rises, lifting inner bollard tube 12 until shoulder 12c engages outer bollard shoulder 11d. From this point, inner bollard 12 and outer bollard 11 both rise in conjunction with each other. Both bollard tubes 11 and 12 continue to rise as shaft 9 continues to turn, until outer bollard shoulder 11c engages access flange 3, as previously described. At this point, both the inner and outer bollard tubes are fully extended and sealed by seals 130.

Retraction of bollard components 10 and 11 is accomplished by rotating drive head 5 in a second direction opposite to the first direction. During retraction of the bollard assembly, sufficient residual lubricant adheres to the shaft threads to facilitate retraction of the shaft back into the stanchion without the application of additional lubricant.

The overlapping of inner bollard tube 12 with outer bollard tube 11, and the overlapping of inner bollard reinforcement with inner bollard tube 12, greatly enhance the strength and impact resistance of the bollard assembly. Low friction components combined with a recirculating lubrication system contribute to long service life. In addition, all bollard components (except for the concrete encased housing) are removable for post-installation servicing.

It will be understood that the foregoing description of the present invention is for illustrative purposes only. As such, the various structural and operational features herein disclosed are susceptible to a number of modifications commensurate with the abilities of one of ordinary skill in the art, none of which departs from the scope of the present invention. Other modifications will be understood in accordance with the contemplated breadth of the present inventions. The preceding description, therefore, is not meant to limit the scope of the invention. Rather, the scope of the invention is to be determined only by the appended claims and their equivalents.

1. A shaft assembly comprising:
a shaft having a plurality of threads formed therealong; and
a shaft housing structure including a lubricant source in fluid communication with a threaded portion of the shaft, a lubricant positioned in the lubricant source in contact with the threaded portion of the shaft, a funnel portion in fluid communication with the lubricant source, a shaft guide portion in fluid communication with the funnel portion, and a shaft exit portion through which a portion of the shaft projects to an exterior of the housing, the shaft exit portion being in fluid communication with the shaft guide portion, the shaft exit portion defining a flow path for the lubricant to the lubricant source, wherein rotation of the shaft urges lubricant from the lubricant source sequentially into the funnel portion, the shaft guide portion, and the shaft exit portion, whereby the lubricant is returned to the lubricant source.

2. A bollard assembly including a shaft assembly in according to claim 1.

3. A valve assembly comprising:
a valve body;
a valve assembly portion coupled to the valve body, the valve assembly portion having an orifice formed therein;
a spring-actuated closure member positioned within the valve body for engaging the valve assembly portion orifice to obstruct flow of a fluid through the valve body when a pressure differential between an interior of the valve body and an exterior of the valve body is below a predetermined value.

4. A bollard assembly including a valve assembly according to claim 3.

5. The valve assembly of claim 3 wherein a cross section of the valve assembly portion orifice is bounded by a first plane forming a first substantially circular conical section having a first diameter, and a second plane parallel to the first plane and forming a second substantially circular conical section substantially coaxial with the first conical section, the second conical section having a second diameter different from the first diameter.

6. The valve assembly of claim 5 wherein the closure member has a conical tip substantially conforming to a cross-sectional shape of the one of the first the valve assembly portion orifice and the second valve assembly portion orifice to seal orifice.

7. The valve assembly of claim 3 wherein the closure member has a substantially conical tip insertable into the valve assembly portion orifice to seal the orifice.

8. The valve assembly of claim 3 wherein at least a portion of the closure member is spaced apart from an interior surface of the valve body such that the fluid flows between the at least a portion of the closure member and the interior surface of the valve body when the closure member is disengaged from the valve assembly portion orifice.

9. The valve assembly of claim 8 wherein the closure member has a substantially square cross-section and the valve body has a substantially circular cross-section.

10. A telescoping bollard assembly comprising:
a housing;
an outer bollard tube slideably positioned within the housing; and
an inner bollard tube slideably positioned within the outer bollard tube,
wherein a portion of the inner bollard tube overlaps a portion of the housing when the bollard assembly is fully extended.

11. The bollard assembly of claim 10 wherein a first portion of the inner bollard tube extends from the housing, a first portion of the outer bollard tube extends from the housing, and wherein the bollard assembly further comprises a cover coupled to the housing for enclosing the first portion of the inner bollard tube and the first portion of the outer bollard tube.

12. The bollard assembly of claim 10 wherein a first portion of the inner bollard tube extends from the housing, a first portion of the outer bollard tube extends from the housing, a portion of the outer bollard tube overlapping a portion of the inner bollard tube, and wherein the bollard assembly further comprises a reinforcing member positioned within the inner bollard tube and overlapping at least part of the portion of the inner bollard tube overlapped by the outer bollard tube.

13. A system for securing a bollard assembly, the system comprising:
a housing containing a member for actuating the bollard assembly;
a cap coupled to the housing and positioned to prevent access to the actuating member; and
a first securement member coupled to the housing and positioned to prevent repositioning of the cap,
wherein repositioning of the first securement member permits repositioning of the cap so as to permit access the actuating member.

14. The system of claim 13 wherein the actuating member comprises a drive head for facilitating rotation of a shaft, and wherein the cap is positioned to cover the drive head.

15. The system of claim 14 wherein the first securement member is positioned to cover at least a portion of the cap to prevent repositioning of the cap to uncover the drive head.

16. The system of claim 14 wherein the drive head includes an interface adapted to receive therein a proprietary tool to enable rotation of the shaft via the drive bead.

17. The system of claim 14 wherein the first securement member includes an interface adapted to receive therein a proprietary tool to enable repositioning of the first securement member.

18. The system of claim 13 further comprising a cover coupled to the housing and positioned to prevent access to the first securement member; and
a second securement member coupled to the housing and positioned to prevent repositioning of the cover.

19. The system of claim 18 wherein the second securement member includes an interface adapted to receive therein a proprietary tool to enable repositioning of the first securement member.

20. The system of claim 19 wherein the second securement tool interface is adapted to receive therein the same proprietary tool as the first securement tool interface.
